(19) United States
(12) Patent Application Publication
(10) Pub. No.: US 2009/0001670 A1
(43) Pub. Date: Jan. 1, 2009

(54) STUFFING-BOX PACKING

(76) Inventors: Manfred SETT, Kempen (DE); Werner Heinze, Wachtendonk (DE)

Correspondence Address: K.F. ROSS P.C., 5683 RIVERDALE AVENUE, SUITE 203 BOX 900, BRONX, NY, 10471-0900, US

(21) Appl. No.: 12/145,805

(22) Filed: Jun. 25, 2008

(30) Foreign Application Priority Data
Jun. 26, 2007 (DE) 102007029620.9

(51) Int. Cl. F16K 41/02

(52) U.S. Cl. 277/510

(57) ABSTRACT

A stuffing-box assembly has a shaft element having an outer surface centered on an axis and a housing element surrounding the shaft element and having an inner surface also generally centered on the axis. One of the elements is shiftable axially and rotatable about the axis relative to the other of the elements. The packing itself is formed by a resilient inner sleeve between the surfaces and having an inner surface engageable with the outer surface of the shaft element and an outer surface formed with a pair of frustoconical surfaces and a resilient outer sleeve between the surfaces and having an outer surface engageable with the inner surface of the housing element and an inner surface formed with a pair of axially offset frustoconical surfaces complementary to and engaging the frustoconical surfaces of the inner sleeve.

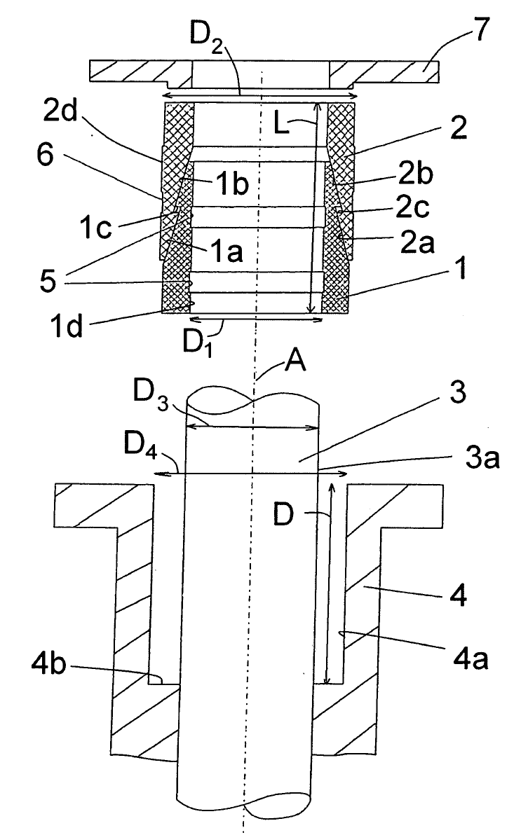

### FIELD OF THE INVENTION

The present invention relates to a stuffing-box packing.

### BACKGROUND OF THE INVENTION

A stuffing box assembly typically comprises a shaft and a housing surrounding it, both centered on an axis of the shaft. Normally the shaft and housing can rotate and/or move axially relative to each other, normally with the housing stationary. A space between an outer surface of the shaft and a confronting inner surface of the housing holds a packing, typically also delimited axially by a floor surface of the shaft and an end face of a closure member or of the shaft. The packing is axially and radially compressed to seal between the housing and the shaft.

One-piece stuffing-box packings having multiple seal sleeves are known from U.S. Pat. No. 5,476,271 or U.S. Pat. No. 2,356,947. If the stuffing box is compressed, the bellows-shaped seals spread and seal the stuffing box space at the shaft.

One disadvantage is that during assembly of the bellows-shaped seal, spreading already occurs due to friction as soon as the first annular surface makes contact with the stuffing-box inner surface and the shaft, before the seal is completely mounted. The seal must then be pressed into the stuffing box with a relatively high force, so that the surfaces of the stuffing-box packing, the stuffing-box inner surface, and the shaft may be damaged by scratches extending axially. When removing the seal from the stuffing-box inner surface, spreading of the seal must likewise be overcome, requiring a corresponding expenditure of force.

Furthermore, it is known from the prior art to provide multiple rings coaxially on top of each other in the stuffing box of sliding or rotating fittings. These rings are made, for example, of silk string. Plaited packing rings require a relatively high axial pressing force in order to generate the required radial sealing force. If these packings are inserted into stuffing boxes coated with plastic, unacceptable deformations, or even damage to the plastic may occur in the area of the stuffing box floor due to the relatively high axial pressing force.

Another solution consists of chevron or V-section seal sleeves. These are preferably produced of polytetrafluoroethylene for applications using corrosive media, and require a stuffing box installation space and shaft diameter mate to tight tolerances. Because of the tight tolerances, manufacture is correspondingly expensive.

### OBJECTS OF THE INVENTION

It is therefore an object of the present invention to provide an improved stuffing-box packing.

Another object is the provision of such an improved stuffing-box packing that overcomes the above-given disadvantages, in particular that is easily inserted into the stuffing box by hand and without any auxiliary means, can also be easily removed, is of a simple construction, and provides a high radial sealing force with low axial compression.

### SUMMARY OF THE INVENTION

A stuffing-box assembly according to the invention has a shaft element having an outer surface centered on an axis and a housing element surrounding the shaft element and having an inner surface also generally centered on the axis. One of the elements is shiftable axially and rotatable about the axis relative to the other of the elements. The packing itself is formed by a resilient inner sleeve between the surfaces and having an inner surface engageable with the outer surface of the shaft element and an outer surface formed with a pair of frustoconical surfaces and a resilient outer sleeve between the surfaces and having an outer surface engageable with the inner surface of the housing element and an inner surface formed with a pair of axially offset frustoconical surfaces complementary to and engaging the frustoconical surfaces of the inner sleeve.

Due to the fact that the stuffing-box packing for an element that rotates and moves axially has two separate seal sleeves that are connected to each other in a positive fit, the inner sleeve having at least two frustoconical sections on its outer surface and the outer sleeve complementary frustoconical sections on its inner surface, a stuffing-box packing having a simple construction of at least two seals or seal sleeves engaging into each other is created that can be easily installed without any tools, e.g. inserted into the stuffing box housing.

It is of particular advantage that the stuffing-box packing according to the invention be manufactured inexpensively and can compensate for considerable shape and tolerance deviations of the stuffing-box inner surface and the shaft. Furthermore, the invention allows a sufficiently high radial sealing force with a low axial pressing force to be achieved.

In a preferred embodiment the frustoconical sections of the two seals are each provided axially offset from one another. Preferably, the frustoconical sections or surfaces of the inner sleeves, which are provided offset from one another, form at least one annular shoulder that can be engaged by a complementary annular shoulder of the outer sleeve.

In this manner it is possible to create a positive-fit connection, since one shoulder is created at each seal by means of the geometric design and arrangement of the frustoconical surfaces provided offset from one another, the shoulder serving for the positive fitting connection of the seals or of the seal sleeves. Thus a solid interconnection of the stuffing-box packing is achieved with a simple construction.

Preferably the number of frustoconical sections on the inner sleeve corresponds to the number of the complementary frustoconical sections on the outer sleeve or seal sleeve, and preferably each seal has two frustoconical sections or surface areas that are provided axially offset from each other.

Preferably the inner sleeve has when relaxed, that is when not compressed or tensioned, a larger inner diameter than the shaft diameter to be sealed, and/or the outer sleeve has a smaller outer diameter than the diameter of the stuffing box interior space to be sealed. In this manner a simple installation is enabled, reliable sealing being achieved under load, e.g. under application of an axial force on the stuffing-box packing.

Preferably the inner surface of the inner sleeve has one or multiple annular groove that preferably have a depth of from 0.2 to 0.3 mm. Alternatively, or cumulatively, one or multiple annular grooves may be provided on the outer surface of the outer sleeves, which may also have a depth of from 0.2 to 0.3 mm. These grooves act like a stack of seals during operation.

### BRIEF DESCRIPTION OF THE DRAWING

The above and other objects, features, and advantages will become more readily apparent from the following description, reference being made to the accompanying drawing whose sole FIGURE is an exploded view of a stuffing box and seal according to the invention.

### SPECIFIC DESCRIPTION

As seen in the drawing a stuffing-box seal according to the invention has an inner sleeve part 1 and an outer sleeve part 2 made of an elastically deformable material, preferably PTFE. The inner sleeve sleeve 1 is formed on its outer surface with two frustoconical surfaces 1a and 1b that are provided offset from the other relative to an axis A on which the entire assembly is centered. The outer sleeve sleeve 2 is has on its inner surface two respective complementary frustoconical surfaces 2a and 2b, e.g. also offset axially from one another. Between the surfaces 1a and 1b is an annular and planar shoulder 1c that is directed axially inward and that confronts a complementary shoulder 2c between the surfaces 2a and 2b.

Before assembly, the sleeves 1 and 2 are fitted loosely together with the two shoulders 1c and 2c in engagement and the surfaces 1a and 1b at most bearing lightly outward on the surfaces 2a and 2b. In this position both sleeves 1 and 2 are neither stretched or compressed.

When the sleeves 1 and 2 in this rest position are engaged over a shaft 3 so that a cylindrical inner surface 1d of the inner sleeve 1 bears against a cylindrical outer surface 3a of the shaft 3 and then the sleeves 1 and 2 are pressed into a stuffing box 4 so that a cylindrical outer surface 2d of the outer sleeve 2 comes to bear on the cylindrical inner surface 4a of the box 4. The two sleeves 1 and 2 are pushed down so the inner sleeve 1 bears directly on a planar floor 4b of the box 4, then a closing element 7, shown here as a large washer, is clamped down atop the end of the outer sleeve 2, normally with an end projection fitting between the surfaces 3a and 4a to axially compress the sleeves 1 and 2 together in the cylindrical annular cavity between the shaft 3 and housing 4.

An overall length L of the two sleeves when fitted together with their shoulders 1c and 2c engaging or very close is greater than a depth D of the space in the box 4, so that when this closing element 7 is pressed flat against the top of the box 4 it axially compresses the two sleeves 1 and 2 together, causing the surfaces 1a and 2a and the surfaces 1b and 2b to ride up on each other and increasing the axial spacing between the shoulders 1c and 2c. The result is radial compression of the sleeves 1 and 2 to form a very tight joint. This results is virtually identical to a one-piece seal cartridge.

In relaxed conditions of the sleeves 1 and 2, the inner diameter D₁ of the seal sleeve 1 is slightly larger than the outer diameter D₃ of the shaft 3 to be sealed. The outer diameter D₂ of the seal sleeve 2 is similarly smaller than the inner diameter D₄ of the stuffing-box inner surface 4 to be sealed. In this manner the seals 1 and 2 can be easily fitted into the stuffing-box inner surface by hand, and can be just as easily removed. But when axially compressed, the inner surface 1d moves in and the outer surface 2d moves out.

When the element 7 is removed the two sleeves 1 and 2 can shift axially apart somewhat so that expansion and compression is reversed due to the elasticity of the material of the seal sleeves 1 and 2 so that they can be easily removed from the stuffing box by hand. For this purpose is it of advantage if the angle of the frustoconical offsets is selected so that no self-locking can occur.

As a result of the small apex angle of the frustoconical surfaces 1a, 1b, 2a, and 2b, the relatively low axial pretensioning force applied by the element 7 is transformed into a high radial pressing force due to the frustoconical shape, namely exactly at those radial surfaces 1a, 1b, 2a, and 2b at which the sealing is to take place. The radial pressing force in combination with the radial friction in the stuffing-box inner surface 4a and at the shaft 3 lead to the seal hardly transferring any axial force in the area of the stuffing box base 4b at all due to its radial clamping effect so that no unacceptable deformations of the stuffing box base are likely to occur, even in the case of a stuffing box coated with plastic.

The inner surface 1d of the inner sleeve sleeve 1 is made in the embodiment with multiple annular and radially inwardly open grooves 5 that are preferably only 0.2 to 0.3 mm deep. Identical but radially outwardly open grooves 6 are provided on the outer surface 2d of the outer sleeve sleeve 2. In this manner the surface pressure is increased in the seal area toward the shaft 3 and toward the stuffing box 4 in order to increase the sealing effect, thus quasi simulating the sealing effect of seal sleeves that are stacked. In an alternative that is not illustrated, only one groove 5 or 6 is provided.

We claim:

1. A stuffing-box assembly comprising:
a shaft element having an outer surface centered on an axis;
a housing element surrounding the shaft element and having an inner surface also generally centered on the axis, one of the elements being shiftable axially and rotatable about the axis relative to the other of the elements;
a resilient inner sleeve between the surfaces and having an inner surface engageable with the outer surface of the shaft element and an outer surface formed with a pair of frustoconical surfaces; and
a resilient outer sleeve between the surfaces and having an outer surface engageable with the inner surface of the housing element and an inner surface formed with a pair of axially offset frustoconical surfaces complementary to and engaging the frustoconical surfaces of the inner sleeve.

2. The assembly defined in claim 1 wherein the frustoconical surfaces of the inner sleeve are separated by an axially directed generally shoulder and the frustoconical surfaces of the outer sleeve are separated by another axially directed shoulder that axially confronts the shoulder of the inner sleeve.

3. The assembly defined in claim 2 wherein the shaft outer surface and housing inner surface are cylindrical and centered on the axis.

4. The assembly defined in claim 3 wherein in a relaxed position of the sleeves with the sleeves fitting together and the shoulders engaging each other or closely spaced, the outer sleeve has an outer diameter smaller than the housing inner diameter and the inner sleeve has an inner diameter smaller than the shaft outer diameter.

5. The assembly defined in claim 1 wherein the inner surface of the inner sleeve is formed with at least one radially inwardly open groove.

6. The assembly defined in claim 5 wherein the groove has a radial depth of 0.2 to 0.3 mm.

7. The assembly defined in claim 1 wherein the outer surface of the outer sleeve is formed with at least one radially outwardly open groove.

8. The assembly defined in claim 7 wherein the groove has a depth of 0.2 to 0.3 mm.

9. The assembly defined in claim 1 wherein the frustoconical surfaces have small acute apex angles.

10. The assembly defined in claim 1 wherein the sleeves are made of polytetrafluoroethylene.
